(19) United States
(12) Patent Application Publication
(10) Pub. No.: US 2006/0019018 A1
(43) Pub. Date: Jan. 26, 2006

(54) Tea-based beverage

(75) Inventors: James MacKay, Sharnbrook (GB); Malcolm Stratford, Raunds (GB)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Conopco, Inc., d/b/a UNILEVER

(21) Appl. No.: 11/184,685

(22) Filed: Jul. 19, 2005

(30) Foreign Application Priority Data
Jul. 20, 2004 (GB) 0416200.4

(51) Int. Cl. A23L 2/00

(52) U.S. Cl. 426/590

(57) ABSTRACT

An ambient stable tea-based beverage having a pH of from 1 to 4.5 comprising from 0.01 to 3 wt% tea solids, from 100 to 300 ppm sorbic acid, from 100 to 300 ppm benzoic acid and from 100 to 280 ppm of a polyphosphate having the formula M-[-MPO₄—)ₙ-M, where n is from 5 to 22 and M is independently selected from the sodium and potassium atoms is provided.

The present invention relates to an ambient stable tea-based beverage.

### BACKGROUND AND PRIOR ART

In recent years there has been an ever increasing choice for consumers who wish to quench their thirst with ready made beverages. Many of those are now turning from the well known soft drinks to tea based beverages, be those carbonated or still, and the “natural” refreshment they can provide. Tea contains a complex combination of enzymes, biochemical intermediates and structural elements normally associated with plant growth and photosynthesis. There are also many natural substances that give tea its unique taste, astringency, aroma and colour. Many of these are produced by the oxidation reactions that occur during the so-called fermentation stage of black tea manufacture. Tea production has long been driven by traditional processing methods with only a fundamental understanding of the chemistry that is involved. As a consequence manufacturers have discovered making ambient stable tea based beverages at the volumes required to compete with more traditional soft drinks is not simply a matter of flavouring a soft drink with tea.

The flavour of a tea based beverage and its stability rely on the stability of the beverage as a whole. It is therefore critical to preserve the quality of the beverage. The yeasts and molds that can grow in tea based beverages and other soft drinks can be killed or controlled by heat treatment or by use of preservatives. Some tea based beverages are therefore pasteurised and then bottled in glass or special heat stable PET containers. This is known as “hot filling”. Unfortunately this can be an expensive operation which creates a great deal of environmentally unfriendly waste. It has therefore become more attractive for manufacturers to pack their tea based products in standard PET containers which can range from single serve units to multi-serve packs and maintain the stability of the product using tailor made flavour and preservative systems. This is known as “cold filling”. It is also useful in that one can readily use a tea concentrate or powder.

Potassium sorbate is well known preservative. It is a mold and yeast inhibitor and one of the few legally permitted preservatives of soft drinks and fruit juices. It has been listed in the UK Preservatives in Food regulations since at least 1962. The levels of use tend to be in the range of 100-1000 ppm. That has been found to be an effective antimicrobial agent in a variety of foods including carbonated beverages in certain fruit and vegetable products, including wines. It is sorbic acid that is the effective agent. Another well-known preservative is sodium benzoate.

Unfortunately even moderate levels of sorbic or benzoic acid can seriously affect the flavour of a tea based beverage. Adding a strong flavour such as lemon can offset the preservative taste. However consumers are keen to experience other flavours, often more delicate flavours. Furthermore, some of those consumers that were drawn to tea based products as a more healthy and natural alternative to soft drinks would reduce their intake of preservatives generally.

Many countries have regulations that prohibit the use of certain food additives, including some preservatives, in foods and beverages. Regulations can vary widely but there is a clear trend for foods to contain fewer and lower levels of chemical preservatives, particularly synthetic ones.

WO 01/87095 suggests a tea based beverage, that contains a preservative system comprising 1 to 175 ppm cinnamic acid, 10 to 200 ppm sorbic acid or benzoic acid, and at least one essential oil other than cinnamic acid. When the beverage is tea based it preferably contains 0.01 to 3% tea solids, especially about 0.14% tea solids.

However, whilst cinnamic acid has allowed reduced levels of sorbic acid or benzoic acid, it has its own taste problems at concentrations where it has an effective preservative action.

U.S. Pat. No. 3,681,091 teaches that polyphosphates can be used as a preservative in beverages.

WO 95/22910 and WO 96/26648 suggest using high levels of a food grade polyphosphate in combination with high levels of a preservative such as sorbic or benzoic acid.

WO 01/00048 teaches that long chain polyphosphates give a superior preservative action and can allow the level of preservative to be reduced. However, it teaches that a level of at least 625 ppm long-chain polyphosphate is required for satisfactory yeast and mold inhibition. Therefore it teaches that a still higher level of short chain polyphosphate would be required.

However, none of the prior art documents teach the a tea based beverage made by a “cold filling” technique which has a good shelf life and good taste.

The present inventors have discovered that polyphosphates also have a low taste threshold and that, when combined with a specific preservative system give a good shelf life at unusually low levels, thus providing good taste.

### DETAILED DESCRIPTION OF THE INVENTION

The Beverage

The term “tea based beverage” describes a beverage that contains the solid extracts of leaf material from Camellia sinensis, Camellia assamica, or Aspalathus linearis. The leaves may have subjected to a so-called “fermentation” step wherein they are oxidised by certain endogenous enzymes that are released during the early stages of “black tea” manufacture. This oxidation may even be supplemented by the action of exogenous enzymes such as oxidases, laccases and peroxidases. Alternatively the leaves may have been partially fermented (“oolong” tea) or substantially unfermented (“green tea”). The tea may be added to the beverage in various forms including an extract, a concentrate, a powder or as granules.

Adding tea to media often increases the risk of microbial spoilage. This is probably because tea provides nutrients for microbial growth. Most microbes that can typically grow in tea based beverages thrive on sugar, a source of nitrogen, oxygen, zinc, magnesium, potassium, phosphate and vitamins. It is therefore advantageous to limit the sugar content to 8 to 10 degrees brix, however one could use up to 60 degrees brix when the product is a tea mix. Oxygen content can be minimised by pre-pasteurisation or some heat treatment or nitrogen sparging. The mineral content of a tea based beverage can be minimised using EDTA, citrate, or a water softener. For example microbes can grow in tea if the concentration of magnesium ions exceeds 0.2 ppm, and they only need trace levels of zinc. One must be careful using citrate for this purpose as it can-affect taste.

At low concentrations, such 0.01 to 3%, tea acts as a nutrient that enhances the potential for microbial spoilage. This is unexpected-given the known antibacterial and antiviral properties of tea. It is not until one exceeds a concentration of 3% that tea begins to suppress the growth of yeasts and molds.

An acidulant for the purposes of this invention can be any substance that is added in order to lower the pH of a solution and/or impart a sour taste to a beverage. They are usually weak acids such as citric, malic, acetic, succinic, fumaric, lactic, tartaric, ascorbic acids or dilute mineral acids such as hydrochloric, phosphoric or sulphuric acid. In concentrations as high as 3,000 ppm they tend to have a slight if any antimicrobial effect.

However, for the purposes of the present invention it is highly preferred that no ascorbic acid is present, i.e. 0 ppm.

Ambient-stable tea based beverages of the invention may be still or carbonated. Carbonation appears to provide a preservative effect in itself and therefore the formulation of a carbonated product need not be the same as a still one. The present inventors have observed that carbonation appears to synergistically increase the antimicrobial action of cinnamic acid and at least some weak acid preservatives such as sorbic acid. The partially dissolved carbon dioxide may impair cell wall growth.

The Polyphosphate

The polyphosphate of the present invention is one having the formula M-[-MPO₄—]ₙ-M, where n is from 5 to 22 and M is independently selected from the sodium and potassium atoms. Preferably n is from 7 to 20, or even from 10 to 20.

It has been found that in tea-based beverages, a concentration above 280 ppm has a negative taste effect. Therefore the level of polyphosphate is from 100 to 280ppm. When combined with a preservative system, this level also gives good shelf life. Preferably the level of polyphosphate is from 100 to 250ppm.

The Preservative System

The preservative system of the present invention comprises very low levels of both potassium sorbate and sodium benzoate. Specifically, both are present at levels of from 100 to 300 ppm, preferably from 100 to 250ppm, more preferably from 100 to 200 ppm. This ensures that no negative taste effects are observed.

### EXAMPLES

The following non-carbonated water-based beverage was made up:

| Ingredient | Conc (ppm) |
|---|---|
| Potassium sorbate | 268 |
| Sodium benzoate | 180 |
| SHMP (n = 15) | 250 |
| Tea powder | 1400 |
| Citric acid | 2500 |
| Lemon flavour | 200 |

The beverage was packaged in several PET bottles and was stored at a range of temperatures. The taste was evaluated over various time periods to measure the shelf-life. The following taste scores were obtained.

| | Temperature (° C.) | | |
|---|---|---|---|
| Time(months) | 2 | 20 | 35 |
| 1 | 0.0 | 1.0 | 1.9 |
| 3 | 0.0 | 1.0 | 1.3 |
| 6 | 0.0 | 1.4 | 3.0 |
| 9 | 0.0 | 2.0 | 3.6 |

It can be seen that acceptable taste scores are achieved for up to 6 months shelf-life at ambient temperatures.

Taste Score

The taste score is marked by a trained expert panel in the following manner.

| Score | | |
|---|---|---|
| 0 | Totally Acceptable | Identical To Standard |
| 1 | Totally Acceptable | Very slight difference from standard |
| 2 | Acceptable | Recognisable difference from standard |
| 3 | Borderline | Significantly different from standard |
| | Acceptable | but not unacceptable |
| 4 | Unacceptable | Completely different from standard |
| 5 | Totally | Totally unacceptable |
| | Unacceptable | |

1. An ambient stable tea-based beverage having a pH of from 1 to 4.5 comprising
(a) from 0.01 to 3 wt % tea solids
(b) from 100 to 300 ppm sorbic acid
(c) from 100 to 300 ppm benzoic acid
(d) from 100 to 280 ppm of a polyphosphate having the formula M-[-MPO4-]n-M, where n is from 5 to 22 and M is independently selected from the sodium and potassium atoms.

2. A beverage according to claim 1, which comprises 0 ppm ascorbic acid.

3. A beverage according to claim 1, wherein n is from 7 to 20.
